(19) United States
(12) Patent Application Publication
(10) Pub. No.: US 2025/0333913 A1
(43) Pub. Date: Oct. 30, 2025

(54) ARTIFICIAL TURF CONTAINING A WASHABLE BINDER COMPOSITION

(71) Applicants: Dow Global Technologies LLC, Midland, MI (US); Rohm and Haas Company, Collegeville, PA (US)

(72) Inventors: Albert Carbonell Blanch, Tarragona (ES); Pavel Janko, Tarragona (ES); Asghar A. Peera, Collegeville, PA (US); Sarah R. Zolynski, Collegeville, PA (US)

(21) Appl. No.: 18/864,969

(22) PCT Filed: May 19, 2023
(86) PCT No.: PCT/US2023/022845

§ 371 Date: Nov. 12, 2024

Related U.S. Application Data
(60) Provisional application No. 63/365,038, filed on May 20, 2022.
(60) Provisional application No. 63/365,041, filed on May 20, 2022.

(51) Int. Cl. E01C 13/08; C11D 1/72; C11D 3/04

(52) U.S. Cl. CPC E01C 13/08; C11D 1/72; C11D 3/044; C11D 2111/40

(57) ABSTRACT

The present disclosure provides an artificial turf. In an embodiment, the artificial turf includes a primary backing layer having a plurality of artificial turf yarns projecting upwardly therefrom. The artificial turf also includes a secondary backing layer in contact with the primary backing layer. The secondary backing layer is made of an acrylic binder. The acrylic binder includes (i) an acrylic polymer composed of polymerized units of (a) a first monomer that is a C₄-C₁₈ alkyl acrylate and (b) a second monomer selected from acrylic acid, methacrylic acid, and a C₁-C₃ alkyl acrylate optionally containing a hydroxyl group. The acrylic binder also includes (ii) at least one inorganic neutralizer, and (iii) at least one surfactant.

### BACKGROUND

Interest in artificial turf in recent years has been explosive. Artificial turf (otherwise known as “pitch”) is increasingly used to replace natural grass on playing surfaces, in particular on sports fields and playgrounds. Artificial turf also finds application in landscaping and leisure settings.

Current turf structures contain different materials, the turf yarns, the primary backing layer, and the secondary backing layer, which causes a difficult recyclability of the pitch. The secondary backing layer is typically a coated layer providing “tuft-lock” of the turf yarn in the primary backing layer, which is an important parameter for the durability of the pitch. Conventional coated layer compositions used as the secondary backing layer are made with latex (several types of latex exist natural rubber (NR), SIS (styrene-isoprene rubber), SBR (styrene-butadiene rubber) and the like. The SBR is the most common type of synthetic latex used in the production of artificial turf; however, the combination of two rubber layers as SBR/NR and/or a polyurethane layer are also utilized as secondary backing layer. These conventional secondary backing layers negatively affect the recyclability of the artificial turf.

The art recognizes the need for artificial turf with improved recyclability. Specifically, a need exists for artificial turf with a secondary backing layer that provides suitable tuft-lock performance and is also removable permitting separation of the artificial turf into its individual material components.

### SUMMARY

The present disclosure provides an artificial turf. In an embodiment, the artificial turf includes a primary backing layer having a plurality of artificial turf yarns projecting upwardly therefrom. The artificial turf also includes a secondary backing layer in contact with the primary backing layer. The secondary backing layer is made of an acrylic binder (interchangeably referred to as “adhesive composition”). The acrylic binder includes (i) an acrylic polymer composed of polymerized units of (a) a first monomer that is a C₄-C₁₈ alkyl acrylate and (b) a second monomer selected from acrylic acid, methacrylic acid, and a C₁-C₃ alkyl acrylate optionally containing a hydroxyl group. The acrylic binder also includes (ii) at least one inorganic neutralizer, and (iii) at least one surfactant.

### Definitions

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent U.S. version is so incorporated by reference) especially with respect to the disclosure of definitions (to the extent not inconsistent with any definitions specifically provided in this disclosure).

The numerical ranges disclosed herein include all values from, and including, the lower and upper value. For ranges containing explicit values (e.g., from 1 or 2, or 3 to 5, or 6, or 7), any subrange between any two explicit values is included (e.g., the range 1-7 above includes subranges of from 1 to 2; from 2 to 6; from 5 to 7; from 3 to 7; from 5 to 6; etc.).

Unless stated to the contrary, implicit from the context, or customary in the art, all parts and percents are based on weight and all test methods are current as of the filing date of this disclosure.

An “acrylic polymer” is a polymer that contains polymerized acrylic monomer and, optionally, may contain at least one comonomer. An “acrylic monomer,” as used herein, is a monomer with the Structure (I) below:

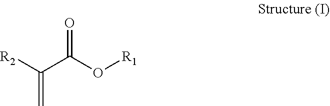

wherein R₁ is a H or a C₁-C₁₈ alkoxy group and R₂ is H or CH₃. Non-limiting examples of acrylic monomers include acrylic acid, methacrylic acid, acrylates, and methacrylates.

The term “alkyl” is a univalent hydrocarbon. A “hydrocarbon” is a compound composed of only hydrogen atoms and carbon atoms and containing straight chains and/or branched chains.

The terms “amine” and “amino” refer to both unsubstituted amine (e.g. NH₃ and NH₄⁺) and substituted amines (e.g., mono-substituted amines or di-substituted amines), wherein substituents may include, for example, alkyl, cycloalkyl, heterocyclyl, alkenyl, and aryl.

The terms “blend” or “polymer blend,” as used, refers to a mixture of two or more polymers. A blend may or may not be miscible (not phase separated at molecular level). A blend may or may not be phase separated. A blend may or may not contain one or more domain configurations, as determined from transmission electron spectroscopy, light scattering, x-ray scattering, and other methods known in the art. The blend may be effected by physically mixing the two or more polymers on the macro level (for example, melt blending resins or compounding), or the micro level (for example, simultaneous forming within the same reactor).

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

An “ethylene-based polymer” or “ethylene polymer” is a polymer that contains a majority amount of polymerized ethylene based on the weight of the polymer and, optionally, may comprise at least one comonomer. Ethylene-based polymers typically comprise at least 50 mole percent (mol %) units derived from ethylene (based on the total amount of polymerizable monomers).

An “olefin-based polymer” is a polymer containing, in polymerized form, a majority mole percent polymerized olefin monomer (based on total amount of polymerizable monomers), and optionally, may contain at least one comonomer. Nonlimiting examples of olefin-based polymer include ethylene-based polymer and propylene-based polymer.

The term “polymer” or a “polymeric material,” as used herein, refers to a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to has being based on “units” that are the polymerized form of a corresponding monomer.

A “propylene-based polymer” is a polymer that contains a majority amount of polymerized propylene based on the weight of the polymer and, optionally, may comprise at least one comonomer. Propylene-based polymers typically comprise at least 50 mole percent (mol %) units derived from propylene (based on the total amount of polymerizable monomers).

### Test Methods

Coating Weight. Acrylic binder coat weight is expressed as the weight of dry adhesive on a standard area of material—in grams per square meter (gsm or g/m²). The conditions for drying the coating on the primary backing layer include a drying temperature of 100° C. and a drying time of 15-20 minutes. The size of the samples on which the coating is applied is 15×15 cm.

Removability. The removability of the secondary backing layer is defined as follows:

$$Removability \% = ( 1 - \frac{Tuft lock ( after washing )}{Tuftlock ( before washing )} ) \times 100 \%$$

Removability has been defined as the difference in tuft-lock after washing and before washing. A high removability implies that the tuft-lock has decreased enough to ensure a proper separation of the yarn from the primary backing afterwards, meanwhile a low removability would imply that no secondary backing has been removed and therefore separation of yarn and primary backing is not happening.

The tuft-lock test measures the withdrawal force (in Newtons per inch or N/inch) needed to remove a tuft of yarns from the primary backing layer. The tuft-lock test is performed in accordance with ISO 4919. The process starts with installing a base plat so that this is flat, on a plane perpendicular to the direction of the tuft withdrawal. Select one of the whole tufts and attach it into the clamp, meanwhile the carpet should be clamped to the base plate. Conduct the test according to the conditions in the table below. Repeat the test for a minimum of 20 tufts, spread over the sample. The results are then recorded as the mean tuft withdrawal force. Tuft-lock conditions are provided in the table below. The size of the sample is 15×15 cm.

| Tuft-lock (ISO 4919) | Value |
|---|---|
| Testing conditions | 20 ± 2° C. |
| Speed | 100 mm/min |
| Gripping | One end of a tuft |
| Number of test | >20 |

### BRIEF DESCRIPTION OF THE DRAWINGS

FIG. 1 is a side elevational view of an artificial turf in accordance with an embodiment of the present disclosure.

FIG. 2 is a graph showing the tuft-lock obtained on comparative samples and the inventive example before performing the wash step.

### DETAILED DESCRIPTION

The present disclosure provides an artificial turf. In an embodiment, the artificial turf includes a primary backing layer having a plurality of artificial turf yarns projecting upwardly therefrom. The artificial turf also includes a secondary backing layer in contact with the primary backing layer. The secondary backing layer is made of an acrylic binder (interchangeably referred to as “adhesive composition”). The acrylic binder includes (i) an acrylic polymer composed of polymerized units of (a) a first monomer that is a C₄-C₁₈ alkyl acrylate and (b) a second monomer selected from acrylic acid, methacrylic acid, and a C₁-C₃ alkyl acrylate optionally containing a hydroxyl group. The acrylic binder also includes (ii) at least one inorganic neutralizer, and (iii) at least one surfactant.

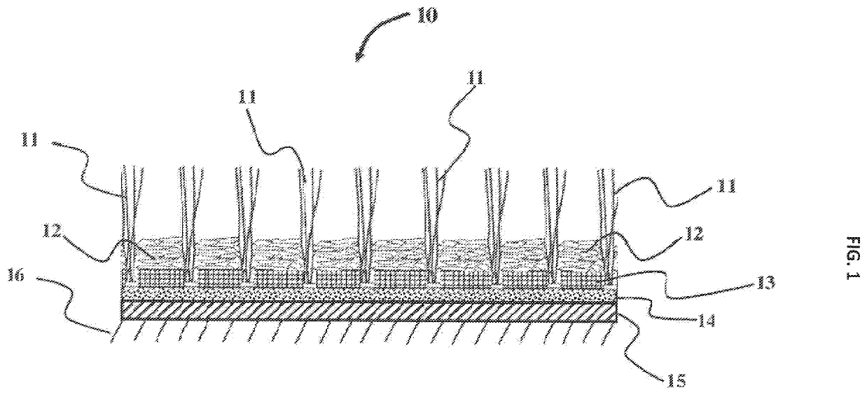

FIG. 1 shows an embodiment of the present artificial turf 10 having a primary backing layer 13, with a plurality of artificial turf yarns 11 projecting upwardly therefrom. The term “artificial turf,” as used herein, is a carpet-like cover having substantially upright, or upright, polymer strands of the artificial turf yarn 11 projecting upwardly from a substrate which is the primary backing layer 13. The artificial turf 10 may optionally include an infill 12 and a shock absorption layer 15. The artificial turf 10 also includes a secondary backing layer 14. The secondary backing layer 14 contacts the primary backing layer 13. As shown in FIG. 1, the artificial turf yarns 11, the primary backing layer 13, the secondary backing layer 14, and the shock absorption layer 15 may be attached to each other and the infill 12 can be spread on top of the artificial turf yarns 11. The artificial turf 10 can be disposed on the ground surface 16 or other desired surface.

The present artificial turf 10 includes a plurality of artificial turf yarns 11 projecting upwardly from the primary backing layer 13. The term “artificial turf yarn” or hereafter “yarn,” as used herein, includes fibrillated tape yarn, co-extruded tape yarn, monotape yarn and monofilament yarn. A “fibrillated tape” or “fibrillated tape yarn,” is a cast extruded film cut into tape (typically about 1 cm width), the film stretched and long slits cut (fibrillated) into the tape giving the tape the dimensions of grass blades. A “monofilament yarn” is extruded into individual yarn or strands with a desired cross-sectional shape and thickness followed by yarn orientation and relaxation in hot ovens. The artificial turf yarn forms the polymer strands for the artificial turf. Artificial turf requires resilience (springback), toughness, flexibility, extensibility and durability. Consequently, artificial turf yarn excludes yarn for fabrics (i.e., woven and/or knit fabrics).

The artificial turf yarn 11 is composed of a polymeric material. Nonlimiting examples of suitable polymeric material for the yarn include olefin-based polymer (such as propylene-based polymer and/or ethylene-based polymer), polyester, nylon, and combinations thereof. In an embodiment, the artificial turf yarn 11 is composed of an ethylene-based polymer.

The artificial turf 10 may optionally include an infill 12. Nonlimiting examples of infill materials include mixtures of granulated rubber particles like SBR (styrene butadiene rubber) recycled from car tires, EPDM (ethylene/propylene/diene terpolymer), other vulcanized rubbers or rubber recycled from belts, thermoplastic elastomers (TPEs), thermoplastic vulcanizates (TPVs) and mixtures thereof.

The primary backing layer 13 is one or more sheets onto which the artificial turf yarn 11 is sewn or woven such that the artificial turf yarn 11 extends outwardly from the top side of the primary backing layer 13. The primary backing layer may be a polymeric sheet of woven fabric or a polymeric sheet of non-woven fabric. The primary backing layer provides dimensional stability for the artificial turf system.

Nonlimiting examples of suitable polymeric material for the primary backing layer include styrene-butadiene (SB) latex and propylene-based polymer. In an embodiment, the primary backing layer is composed of an olefin-based polymer, such as a propylene-based polymer. In a further embodiment, the primary backing layer is composed of propylene homopolymer (or “polypropylene”).

The artificial turf 10 may optionally include a shock absorption layer 15 underneath the secondary backing layer 14 of the artificial turf 10. The shock absorption layer 15 can be made from polyurethane, PVC foam plastic or polyurethane foam plastic, a rubber, a closed-cell crosslinked polyethylene foam, a polyurethane underpad having voids, elastomer foams of polyvinyl chloride, polyethylene, polyurethane, polypropylene, and mixtures thereof. Non-limiting examples of a shock absorption layer include, for example, DOW® ENFORCE™ Sport Polyurethane Systems, and DOW® ENHANCE™ Sport Polyurethane Systems.

The artificial turf 10 may optionally include a drainage system (not shown in FIG. 1). The drainage system allows water to be removed from the artificial turf 10 and prevents the artificial turf 10 from becoming saturated with water. Nonlimiting examples of drainage systems include stone-based drainage systems, EXCELDRAIN™ Sheet 100, EXCELDRAIN™ Sheet 200, and EXCELDRAIN™ EX-T STRIP (available from American Wick Drain Corp., Monroe, N.C.).

The secondary backing layer 14 is a layer of material in direct contact with the bottom side of the primary backing layer 13 and provides tuft-lock to the artificial turf yarns 11. The term “in direct contact with” or “directly contacts” refers to a layer configuration whereby a first layer is located immediately adjacent to a second layer and no intervening layers or no intervening structures are present between the first layer and the second layer. “Tuft-lock” of the artificial turf yarns is defined as the force (in N/inch) needed to remove a bundle of yarns from the primary backing layer. This parameter is required in both landscaping as well as sports applications to ensure a correct durability of the field, as no tuft-lock will lead to a low durability of the field.

The secondary backing layer includes an acrylic binder (interchangeably referred to as “adhesive composition”). The acrylic binder contains an acrylic polymer composed of polymerized units of (a) a first acrylic-based monomer that is a C₄-C₁₈ alkyl acrylate and (b) a second acrylic-based monomer selected from acrylic acid, methacrylic acid, a C₁-C₃ alkyl acrylate optionally containing a hydroxyl group, and combinations thereof.

Nonlimiting examples of suitable C₄-C₁₈ alkyl acrylate include butyl acrylate (BA), butyl methacrylate, 2-ethylhexyl acrylate (2-EHA), octyl acrylate, isooctyl methacrylate, decyl methacrylate, isodecyl methacrylate, lauryl methacrylate, pentadecyl methacrylate, and stearyl methacrylate.

Nonlimiting examples of suitable C₁-C₃ alkyl acrylate optionally containing a hydroxyl group include methyl acrylate, ethyl acrylate, propyl acrylate, hydroxyethyl acrylate, hydroxyethyl methacrylate, hydroxypropyl acrylate, and hydroxypropyl methacrylate.

In an embodiment, the acrylic polymer does not contain an olefinic monomer. Nonlimiting examples of olefinic monomers (which are excluded from the acrylic polymer) include ethylene, propylene, 1,3-butadiene, pentene, hexene, octene, styrene, and 5-ethylidene-2-norborene.

In an embodiment, the acrylic polymer does not contain a vinyl chloride monomer.

In an embodiment, the acrylic polymer contains a third acrylic-based monomer that has a carboxylic acid functional group. Nonlimiting examples of the third monomer include acrylic acid, methacrylic acid, and itaconic acid. In an embodiment, the acrylic polymer is a 2-ethylhexyl acrylate/ethyl acrylate/acrylic acid terpolymer.

In an embodiment, the acrylic polymer contains, based on the total weight of the acrylic polymer, (i) from 50 wt % to 90 wt %, from 60 wt % to 80 wt %, from 65 wt % to 75 wt %, or from 50 wt % to 71 wt %, of the first monomer that is a C₄-C₁₈ alkyl acrylate, (ii) from 20 wt % to 50 wt %, from greater than 20 wt % to 40 wt %, or from 25 wt % to 40 wt % of the second monomer selected from acrylic acid, methacrylic acid, and a C₁-C₃ alkyl acrylate optionally containing a hydroxyl group, and optionally (iii) from 0.5 wt % to 20 wt %, from 1 wt % to 10 wt %, or from 1 wt % to 5 wt % of the third monomer that has a carboxylic acid functional group.

In addition to the acrylic polymer, the adhesive composition for the secondary backing layer includes an inorganic neutralizer. The term “neutralizer” refers to a basic substance that can react with an acidic material in an acid-base reaction. The term “inorganic neutralizer” refers to a neutralizer composed of a metal cation and a basic anion. Nonlimiting examples of a metal cation include a cation of an alkali metal (Group I of the periodic table) and an alkaline earth metal (Group II of the periodic table), such as Li⁺, Na⁺, K⁺, Cs⁺, Mg²⁺, and Ca²⁺. Nonlimiting examples of a basic anion include hydroxide (OH). Nonlimiting examples of suitable inorganic neutralizers include sodium hydroxide, potassium hydroxide, lithium hydroxide, and combinations thereof.

In an embodiment, the at least one inorganic neutralizer is sodium hydroxide.

In an embodiment, the inorganic neutralizer excludes organic amine, or otherwise does not contain an amino group. In other words, the inorganic neutralizer excludes, or otherwise is void of, nitrogen atom (N).

The acrylic binder of the secondary backing layer includes at least one surfactant. The surfactant can be a fatty alcohol ether sulfate. In an embodiment, the fatty alcohol ether sulfate includes a sodium salt of C₁₂-C₁₄ fatty alcohol ether sulfate. Commercially available examples of suitable surfactants include, but are not limited to, Disponil® FES 77 (containing ethoxylate sodium lauryl ether sulfate), FES 32 (containing sodium salt of fatty alcohol polyglycol ether sulfate), FES 993 (containing sodium salt of fatty alcohol polyglycol ether sulfate), and FES 61 (containing sodium salt of fatty alcohol polyglycol ether sulfate), each of which is available from BASF.

In an embodiment, the acrylic binder contains other surfactants. Nonlimiting examples of suitable additional surfactants include sodium dioctyl sulfosuccinate and acetylenic diol ethylene oxide/propylene oxide adduct surfactants.

In an embodiment, the acrylic binder contains, based on the total weight of the acrylic binder, from 0.1 wt % to 3 wt %, or from 0.2 wt % to 1.5 wt %, or from 0.2 wt % to 1 wt % of sodium dioctyl sulfosuccinate surfactant. A nonlimiting example of a suitable commercially available sodium dioctyl sulfosuccinate surfactant is Aerosol® OT-75.

In an embodiment, the acrylic binder contains, based on the total weight of the adhesive composition, from 0.05 wt % to 1.5 wt %, or from 0.1 wt % to 1 wt %, or from 0.1 wt % to 0.5 wt % of the acetylenic diol ethylene oxide/propylene oxide adduct surfactant. Nonlimiting examples of suitable commercially available acetylenic diol ethylene oxide/propylene oxide adduct surfactants include SURFYNOL® 440, SURFYNOL® 104, SURFYNOL® 420, SURFYNOL 450, SURFYNOL® 465, and SURFYNOL® 485.

In an embodiment, the acetylenic diol ethylene oxide/propylene oxide adduct surfactant can be replaced or combined with a non-ionic branched secondary alcohol ethoxylate surfactant. Nonlimiting examples of suitable non-ionic branched secondary alcohol ethoxylate surfactants include TERGITOL™ TMN-10.

In an embodiment, the adhesive composition optionally contains defoamers. Commercially available defoamers include, but are not limited to, Tego Antifoam 2291, Foamaster MO S090, Tego Antifoam KS 53, Tego Antifoam 2450, Tego Antifoam D 2315, BYK 011.

Additionally, acid containing, cross-linked acrylic emulsion copolymers such as alkali-swellable acrylic emulsion (ASE) can be added to assist with the rheology and wash off performance of the polymer. Acceptable additives include, but are not limited to, ACRYSOL™ ASE-60. Additionally, rheology modifiers such as hydrophobically modified alkali swellable (HASE) associative thickener, can be added to assist with the rheology and wash off performance of the polymer. Acceptable additives include, but are not limited to, ACRYSOL™ RM-7, and ACRYSOL™ RM-55.

In an embodiment, the acrylic binder contains water.

Other additives that can be added to the acrylic binder include one or more water soluble additives that can improve the wash off performance of the secondary backing layer. Nonlimiting examples of water soluble additives include synthetic water soluble polymers such as polyethylene glycol (PEG), polyvinylpyrrolidone (PVP), poly(vinyl alcohol) (PVOH), polyacrylic acid (PAA), polyacrylamides, N-(2-hydroxypropyl) methacrylamide (HPMA), divinyl ether-maleic anhydride (DIVEMA), polyoxazoline, polyphosphates, polyphosphazenes, natural water soluble polymers such as xanthan gum, pectins, chitosan derivatives, dextran, carrageenan, guar gum, cellulose ethers, hyaluronic acid (ha), albumin, starch or starch based derivatives, or a combination thereof. Nonlimiting examples of water soluble additives include PEG 400, PEG 600, PEG1000, PEG1450, PEG3350, PEG8000, PVP K60, and PVP K90 with different molecular weights. In an embodiment, the acrylic binder contains, based on the total weight of the acrylic binder, from 0.05 wt % to 20 wt %, or from 0.25 wt % to 10 wt % of one or more additives.

In an embodiment, the acrylic binder is void of, or substantially void of, one, some, or all of the following: an olefinic monomer, a crosslinking component, a tackifier, adipic acid dihydrazide (ADH), a wax, a photo crosslinkable monomer, vinyl acetate, vinyl acetate derivatives, and any combinations thereof.

In an embodiment, the acrylic binder forms the secondary backing layer and includes:
from 80 wt % to 99 wt %, or from 85 wt % to 99 wt %, or from 90 wt % to 99 wt %, or from 95 wt % to 99 wt %, based on the total weight of the acrylic binder, of the acrylic polymer;
from 0.05 wt % to 5 wt %, or from 0.5 wt % to 3 wt %, or from 0.5 wt % to 1 wt %, based on the total weight of the acrylic binder, of the at least one inorganic neutralizer;
from 0.1 wt % to 5 wt %, or from 0.5 wt % to 3 wt %, or from 1 wt % to 3 wt %, based on the total weight of the acrylic binder, of the at least one surfactant.

In an embodiment, the acrylic binder forms the secondary backing layer and includes:
(1) from 80 wt % to 99 wt %, or from 85 wt % to 99 wt %, or from 90 wt % to 99 wt %, or from 95 wt % to 99 wt %, based on the total weight of the acrylic binder, of the acrylic polymer that is a 2-ethylhexyl acrylate/ethyl acrylate/acrylic acid terpolymer composed of
   (i) from 50 wt % to 90 wt %, from 60 wt % to 80 wt %, from 65 wt % to 75 wt %, or from 50 wt % to 71 wt %, based on the total weight of the terpolymer, of 2-ethylhexyl acrylate monomer;
   (ii) from 20 wt % to 50 wt %, from greater than 20 wt % to 40 wt %, or from 25 wt % to 40 wt %, based on the total weight of the terpolymer, of ethyl acrylate monomer; and
   (iii) from 0.5 wt % to 20 wt %, or from 1 wt % to 10 wt %, or from 1 wt % to 5 wt %, based on the total weight of the terpolymer, of acrylic acid monomer;
(2) from 0.05 wt % to 5 wt %, or from 0.5 wt % to 3 wt %, or from 0.5 wt % to 1 wt %, based on the total weight of the acrylic binder, of the at least one inorganic neutralizer that is sodium hydroxide; and
(3) from 0.1 wt % to 5 wt %, or from 0.5 wt % to 3 wt %, or from 1 wt % to 3 wt %, based on the total weight of the acrylic binder, of the at least one surfactant that is a sodium salt of C₁₂-C₁₄ fatty alcohol ether sulfate or ethoxylate sodium lauryl ether sulfate; and the acrylic binder is in direct contact with the primary backing layer at a coat weight from 10 grams per square meter (gsm) to 500 gsm, or from 100 gsm to 300 gsm, or from 100 gsm to 200 gsm.

The present disclosure provides a process. The process includes providing a batch containing the present artificial turf and a wash solution. The artificial turf includes a primary backing layer having a plurality of artificial turf yarns projecting upwardly therefrom. The artificial turf also includes a secondary backing layer in contact with the primary backing layer. The secondary backing layer includes an acrylic binder. The acrylic binder includes (i) an acrylic polymer composed of polymerized units of (a) a first monomer that is a C₄-C₁₈ alkyl acrylate and (b) a second monomer selected from acrylic acid, methacrylic acid, and a C₁-C₃ alkyl acrylate optionally containing a hydroxyl group, (ii) at least one inorganic neutralizer, and (iii) at least one surfactant.

The process includes providing a batch containing the present artificial turf and a wash solution. The wash solution of the batch includes water, a surfactant, and a base. Nonlimiting examples of surfactants that can be included in the wash solution include secondary alcohol ethoxylate. In an embodiment, the surfactant in the wash solution includes a non-ionic secondary alcohol ethoxylate surfactant. Nonlimiting examples of suitable non-ionic secondary alcohol ethoxylate surfactants include TERGITOL™ 15-S-9. In an embodiment, the wash solution contains from 0.05 wt % to 5 wt %, or from 0.1 wt % to 3 wt %, or from 0.5 wt % to 1 wt % of the surfactant, based on the total weight of the wash solution.

The wash solution includes a base. A nonlimiting example of a suitable base that can be included in the wash solution is sodium hydroxide. In an embodiment, the base in the wash solution is sodium hydroxide and it is added to adjust the pH of the washing bath to pH from 7 to 14 or from 10 to 14.

In an embodiment, the wash solution includes from 0.05 wt % to 5 wt %, or from 0.5 wt % to 3 wt %, or from 1 wt % to 2 wt % of the base, based on the total weight of the wash solution.

In an embodiment, the wash solution includes (i) water, (ii) from 0.05 wt % to 5 wt %, or from 0.1 wt % to 3 wt %, or from 0.5 wt % to 1 wt % of a surfactant including a non-ionic secondary alcohol ethoxylate, based on the total weight of the wash solution, and (iii) from 0.05 wt % to 5 wt %, or from 0.5 wt % to 3 wt %, or from 1 wt % to 2 wt % of a base that is sodium hydroxide, based on the total weight of the wash solution.

The process includes contacting the artificial turf with the wash solution under conditions sufficient to separate the secondary backing layer from the primary backing layer.

In an embodiment, the term “contact” or “contacting” refers to immersing the artificial turf in the wash solution. The term “under conditions sufficient to separate the secondary backing layer from the primary backing layer” includes (i) introducing the batch into a a container (such as a mixing device, for example) and (ii) agitating the batch (or mixture) under conditions sufficient to separate the secondary backing layer from the primary backing layer. The mixing device may mechanically agitate the batch, or otherwise the batch can be manually agitated with a stirring rod. Nonlimiting examples of suitable mixing devices include a tub, a bucket, a flask, a beaker, a horizontal ribbon mixer, a paddle mixer, a tumbler mixer, a drum mixer, a static mixer, a planetary mixer, and a premixer. Any of the foregoing mixing devices may be equipped with suitable equipment to mix, agitate, blend, spin, and/or stir the batch (artificial turf and wash solution) therein. The mixing device mixes the artificial turf with the wash solution and brings the secondary backing layer into full contact with the wash solution.

The term “agitate” or “agitating” refers to a motion of mixing, blending, spinning, tumbling, shaking, and/or stirring the artificial turf in the wash solution.

The term “conditions sufficient to separate the secondary backing layer from the primary backing layer” further includes the operation parameters under which the neutralization of the secondary backing layer is promoted. In an embodiment, the conditions sufficient to separate the secondary backing layer from the primary backing layer include (i) the agitation speed of the batch including the artificial turf and the wash solution, (ii) the temperature of the wash solution, and (iii) the pH of the wash solution.

In an embodiment, the conditions sufficient to separate the secondary backing layer from the primary backing layer include one, some, or all of the following parameters:
(i) agitating the artificial turf immersed in the wash solution at a rate from 50 rpm to 1000 rpm, or from 100 rpm to 600 rpm, or from 100 rpm to 500 rpm; and/or
(ii) heating the wash solution to a temperature from 20° C. to 90° C., or from 30° C. to 85° C., or from 50° C. to 85° C., or from 60° C. to 85° C., or from 70° C. to 85° C.; and/or
(iii) adjusting the pH of the wash solution from 7 to 14, or from 7 to 10, or from 7 to 8. In a further embodiment, only the secondary backing layer is swelled, detached and dispersed in the washing bath and other parts of the artificial turf do not react with the wash solution.

Bounded by no particular theory, it is believed the wash solution swells the secondary backing layer, such that some, or all, of the secondary backing layer detaches from the primary backing layer and moves away from the primary backing layer. The term “separate” or “separating” refers to removing some, or all, of the secondary backing layer from the primary backing layer.

In an embodiment, the process further includes removing the artificial turf (with the primary backing layer and a portion of, or no, secondary backing layer) from the wash solution and rinsing the artificial turf with water.

In an embodiment, the process includes:
(1) providing a batch comprising an artificial turf and a wash solution, the artificial turf comprising
   A. a primary backing layer having a plurality of artificial turf yarns projecting upwardly therefrom; and
   B. a secondary backing layer in contact with the primary backing layer, the secondary backing layer comprising an acrylic binder comprising
(i) from 80 wt % to 99 wt %, or from 85 wt % to 99 wt %, or from 90 wt % to 99 wt %, or from 95 wt % to 99 wt %, based on the total weight of the acrylic binder, an acrylic polymer comprising polymerized units of
   (a) from 50 wt % to 90 wt %, from 60 wt % to 80 wt %, from 65 wt % to 75 wt %, or from 50 wt % to 71 wt %, based on the total weight of the acrylic polymer, a first monomer that is a C₄-C₁₈ alkyl acrylate; and
   (b) from 20 wt % to 50 wt %, from greater than 20 wt % to 40 wt %, or from 25 wt % to 40 wt %, based on the total weight of the acrylic polymer, of a second monomer selected from the group consisting of a C₁-C₃ alkyl acrylate optionally containing a hydroxyl group, acrylic acid, and methacrylic acid; and
   (c) from 0.5 wt % to 20 wt %, from 1 wt % to 10 wt %, or from 1 wt % to 5 wt %, based on the total weight of the acrylic polymer, of a third monomer that has a carboxylic acid functional group;
(ii) from 0.05 wt % to 5 wt %, or from 0.5 wt % to 3 wt %, or from 0.5 wt % to 1 wt %, based on the total weight of the acrylic binder, of at least one inorganic neutralizer (such as sodium hydroxide); and
(iii) from 0.05 wt % to 5 wt %, or from 0.5 wt % to 3 wt %, or from 1 wt % to 3 wt %, based on the total weight of the acrylic binder, of at least one surfactant (such as ethoxylate sodium lauryl ether sulfate); and
the wash solution comprising
   (i) water,
   (ii) 0 wt %, or from 0.05 wt % to 5 wt %, or from 0.1 wt % to 3 wt %, or from 0.5 wt % to 1 wt % of a surfactant (such as secondary alcohol ethoxylate, for example), based on the total weight of the wash solution, and
   (iii) from 0.1 wt % to 5 wt %, or from 0.5 wt % to 3 wt %, or from 1 wt % to 2 wt % of a base (such as sodium hydroxide, for example), based on the total weight of the wash solution; and
(2) immersing the artificial turf in the wash solution;
(3) agitating the artificial turf and the wash solution under conditions sufficient to separate the secondary backing layer; and
(4) removing the secondary backing layer from the primary backing layer.

Artificial turf cannot be recycled effectively without separating the individual components from each other. Traditional secondary backing layer such as polyurethane or rubber latex cannot be easily separated from the rest of the artificial turf components. Mechanical waste processing is a common procedure used in the recycling industry, yet the quality of the waste stream is low due to incompatibility between the different materials that compose an artificial turf system. Developing an artificial turf system which can be separated into its individual components is a major interest for the industry, as it would allow cleaner waste streams.

The present artificial turf and the present process advantageously enable the secondary backing layer to be removed from the primary backing layer, enabling the individual components; turf yarn, primary backing layer, and shock absorption layer to separate from each other. The low density components will float on the surface of the wash solution as each component has a unit density less than 1 g/cm³ and acrylic binder from secondary backing will be dispersed in the wash solution in a form of small particles which can be easily filtered out. In this way, each individual artificial turf component can be readily removed from a recycling stream. Turf yarns and primary backing can be mechanically recycled together or they can be further separated, but the quality of the waste stream will be further improved by separating the secondary backing layer from the artificial turf structure.

By way of example, and not limitation, some embodiments of the present disclosure will now be described in detail in the following examples.

### EXAMPLES

### 1. Materials

The materials used in the inventive examples (“IE”) and comparative samples (“CS”) are provided in Table 1 below.

TABLE 1

| Material | Properties | Source |
|---|---|---|
| Primary backing layer 1 | Polypropylene woven | n/a |
| Secondary backing layer | HYPOD ™ 2000 | Dow |
| for CS1 | Polyolefin Dispersion | |
| Secondary backing layer | Latex | LG Chem |
| for CS2 | SB (styrene-butadiene) | |
| Artificial turf yarns 1 | Polyethylene blade yarns | n/a |
| C₄-C₁₈ alkyl acrylate monomer (2-Ethylhexyl acrylate) | 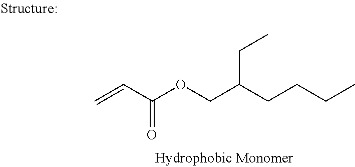 | BASF |
| Monomer (Ethyl acrylate) | 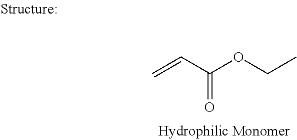 | BASF |
| Monomer (Glacial Acrylic acid) | 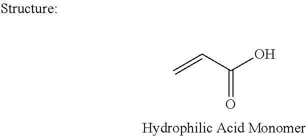 | Dow Chemical |
| Surfactant | Chemical: sodium dodecylbenzenesulfonate (branched) | Stepan |
| (Siponate DS-4) | Sodium salt of branched alkylbenzene sulfonic acid C₁₂H₂₅ | |
| | SO₃Na | |
| | Anionic Surfactant | |
| Surfactant | Chemical: disodium ethoxylated alcohol (C₁₀-C₁₂) half ester | Solvay |
| (Aerosol A-102) | of sulfosuccinic acid; | |
| | CAS No.: 68815-56-5; | |
| | Molecular formula: C₂₆H₄₈O₁₁Na₂S (average); | |
| | Molecular weight: 614 g/mol (average) | |
| | Anionic Surfactant | |
| Inorganic | Chemical: NaOH | Fisher Scientific |
| neutralizer/base | Buffering Agent and Neutralizing Agent | |
| (Sodium hydroxide) | | |
| Surfactant | Chemical: sodium salts of C₁₂-C₁₄ alcohol ethersulfates with | BASF |
| (Disponil Fes-77) | ethoxylation, can be described by the formula below: | |
| | RO(CH₂CH₂O)ₓSO₃Na, with R = C₁₂-C₁₄ and x = 30 | |
| | Anionic Surfactant | |
| Surfactant | Chemical: sodium dioctyl sulfosuccinate in mixture of | Solvay |
| (Aerosol OT-75) | ethanol and water; | |
| | Molecular formula: C₂₀H₃₇O₇NaS | |
| | Molecular weight: 444 g/mol | |
| | Anionic Surfactant, Wetting Agent | |
| Surfactant | Chemical: ethoxylated 2,4,7,9-tetramethyl-5-decyne-4,7- | Evonik |
| (Surfynol 440) | diol; | |
| | CAS No.: 9014-85-1 | |
| | Anionic Surfactant, Wetting Agent | |
| Surfactant | Chemical: secondary alcohol ethoxylate | Dow Chemical |
| (Tergitol 15-S-9) | CAS No.: 84133-50-6 | |

### A. Preparation of CS1-CS3

Uncoated artificial turf samples were used to prepare comparative samples (CS) CS1 and CS2, where secondary backing layers were manually applied to primary backing layer 1 (with artificial turf yarns 1) by brush and then dried in an oven. For CS1, secondary backing layer is based on Dow polyolefin dispersion called HYPOD™ which is applied in a wet form and then dried to form a solid layer fixing the yarns in the primary backing layer. The sample CS2 was made of commercially sourced SB latex which is applied by brush on the primary backing surface and then dried in the oven to form a solid layer fixing the yarns in the primary backing layer. No secondary backing layer was applied for the uncoated sample (CS3).

### B. Synthesis of the Acrylic Polymer in the Acrylic Binder in IE1 Secondary Backing Layer

A monomer emulsion containing 86.31 wt % monomer mixtures was prepared by mixing (i) a monomer composition containing 71 wt % of a first monomer 2-ethylhexyl acrylate, 26 wt % of a second monomer ethyl acrylate, and 3 wt % of a third monomer acrylic acid, based on the total weight of the first, the second, and the third monomers, (ii) sodium dodecylbenzenesulfonate (branched), (iii) Aerosol A-102, and (iv) a small amount of sodium hydroxide (monomer emulsion buffer). Wt % is based on total weight of the polymer batch/emulsion.

With the reactor water held at 90-92° C., the heat was shut off and a solution of 0.054 wt % sodium carbonate and 0.312 wt % sodium persulfate in water was added to the reactor.

0.22 wt % of a polymer latex with diameter 250 nm seed was added to the kettle and held two minutes before the addition of 0.13 wt % of second polymer latex with diameter 100 nm seed

With the reactor at 83° C., a gradual addition thermal polymerization was conducted by feeding the monomer emulsion along with a cofeed of sodium persulfate (0.23 wt %) to the reactor over 150 minutes, while maintaining a reactor temperature of 85-87° C.

After adding 60 wt % of the monomer emulsion feeds, 0.26 wt % polymer latex with diameter <50 nm seed (wt % based on the weight of the monomer composition) was added to the reactor to create a third smaller particle size polymer mode.

At 84° C., promoter was added followed by a chase redox pair of tert-butyl hydroperoxide (0.16 wt %) and D(-)-isoascorbic acid (0.064 wt %) cofeed reagents were fed into the reactor over 45 minutes to reduce the residual monomer levels to final specifications.

At a temperature of 55° C. or less, the reaction was adjusted to a pH of 4 to 4.5 by addition of ammonium hydroxide to produce the acrylic polymer containing 71 wt % 2-EHA, 26 wt % EA, and 3 wt % AA, based on the total weight of the acrylic polymer.

### C. Preparation of the Acrylic Binder in IE1 Secondary Backing Layer

A post-add solution containing 0.26 wt % Surfynol 440, 1.21 wt % Disponil Fes 77, and 0.42 wt % Aerosol OT-75 was added to the acrylic polymer in the kettle over 30 minutes while cooling to 40-45° C. with weight percent based on total weight of the emulsion.

At a temperature of less than 45° C., the inorganic neutralizer (10 wt % aqueous sodium hydroxide) was added until a latex pH of 8-8.5 was reached. Fifteen minutes later, a biocide package was added and the final solids was around 57.5 to 58.5% with weight percent based on total weight of the emulsion.

The obtained acrylic binder (adhesive composition) was filtered through a 100-mesh bag and packed out.

### D. Preparation of IE1

The obtained acrylic binder was applied by paint brush at a coat weight of 150 gsm (wet) on primary backing layer 1 (with artificial turf yarns 1), followed by drying at 100° C. in an oven for 15-20 minutes. The sample was then conditioned in a climate temperature controlled room (CTR) at 23° C.±2° C. and 50% RH±5% RH. Tuft-lock testing was conducted before washing of the acrylic binder (inventive example 1 or “IE1”).

### E. Procedure for Washing CS1, CS2, and IE1

The washing was conducted with a wash solution containing 20 kg of water, 203 g of NaOH (1 wt % water solution), and 100 g of TERGITOL™ 15-S-9 (secondary alcohol ethoxylate) (0.5 wt % water solution). After the wash solution was prepared, the temperature of the wash solution was raised to 75° C.

CS1, CS2, and IE1 were added and immersed in the wash solution. The mixing speed of the washing solution was set to 350 rpm. After 12 minutes of agitation of CS1, CS2, and IE1 in the wash solution, the samples were removed with tweezers, rinsed with fresh water, and then dried at 50° C. in convection oven overnight.

### F. Results

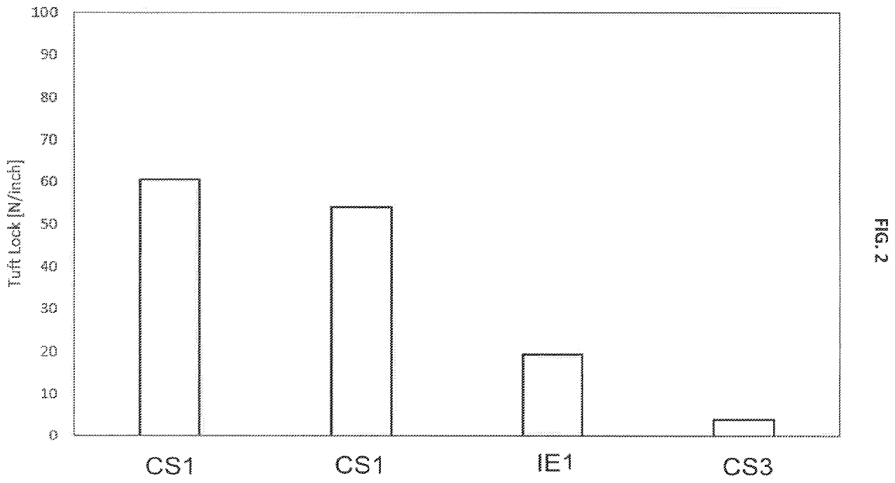

Tuft-lock before washing (pre-wash) step were obtained (measured) on CS1, CS2, and IE1 as a reference. The tuft-lock values (pre-wash) of CS1, CS2, CS3, and IE1 are shown in FIG. 2. CS1 and CS2 had tuft-lock values between 50 N/inch and 60 N/inch, whereas IE1 had a tuft-lock value of 20 N/inch. Compared with the tuft-lock value of CS3 (i.e. less than 5 N/inch), which did not contain any coating on its secondary backing layer, IE1 showed acceptable tuft-lock performance. Even though the tuft-lock values obtained on CS1 and CS2 are higher than that of IE1, IE1 demonstrated tuft-lock performance which can be relevant for specific artificial turf yarn applications (e.g., landscaping or leisure).

Tuft-lock measurements after caustic bath washing were also performed on CS1, CS2, and IE1 (after the washing step) to determine whether the secondary backing layer was removed. The washability of the secondary backing layer in CS1, CS2, and IE1 in the wash solution is defined as removability. The removability of CS1, CS2, and IE1 are provided in Table 2 below.

TABLE 2
removability % of secondary backing
layers containing CS1, CS2, and IE1

| Sample | Removability % |
|---|---|
| CS1 | 0 |
| CS2 | 0 |
| IE1 | >60 |

The removability of the secondary backing layer in IE1 is greater than 60%, whereas the removability of the secondary backing layers in CS1 and CS2 is 0%.

Overall, IE1 contains a secondary backing layer that shows acceptable tuft-lock performance (20 N/inch) and has high removability (greater than 60%), enabling recyclability for the present artificial turf.

It is specifically intended that the present disclosure not be limited to the embodiments and illustrations contained herein, but include modified forms of those embodiments including portions of the embodiments and combinations of elements of different embodiments as come within the scope of the following claims.

1. An artificial turf comprising:
A. a primary backing layer having a plurality of artificial turf yarns projecting upwardly therefrom; and
B. a secondary backing layer in contact with the primary backing layer, the secondary backing layer comprising an acrylic binder comprising
(i) an acrylic polymer comprising polymerized units of
(a) a first monomer that is a C₄-C₁₈ alkyl acrylate; and
(b) a second monomer selected from the group consisting of acrylic acid, methacrylic acid, and a C₁-C₃ alkyl acrylate optionally containing a hydroxyl group;
(ii) at least one inorganic neutralizer; and
(iii) at least one surfactant.

2. The artificial turf of claim 1, wherein the C₄-C₁₈ alkyl acrylate is selected from the group consisting of butyl acrylate, butyl methacrylate, ethylhexyl acrylate, octyl acrylate, isooctyl methacrylate, decyl methacrylate, isodecyl methacrylate, lauryl methacrylate, pentadecyl methacrylate, and stearyl methacrylate.

3. The artificial turf of claim 1, wherein the C₁-C₃ alkyl acrylate optionally containing a hydroxyl group is selected from the group consisting of methyl acrylate, ethyl acrylate, propyl acrylate, hydroxyethyl acrylate, hydroxyethyl methacrylate, hydroxypropyl acrylate, and hydroxypropyl methacrylate.

4. The artificial turf of claim 1, wherein the acrylic polymer is a 2-ethylhexyl acrylate/ethyl acrylate/acrylic acid terpolymer.

5. The artificial turf of claim 4, wherein the terpolymer comprises, based on the total weight of the terpolymer
(i) from 50 wt % to 71 wt % of ethylhexyl acrylate;
(ii) from 25 wt % to 40 wt % of ethyl acrylate; and
(iii) from 1 wt % to 10 wt % of acrylic acid.

6. The artificial turf of claim 1, wherein the at least one inorganic neutralizer is sodium hydroxide.

7. The artificial turf of claim 1, wherein the at least one surfactant comprises a fatty alcohol ether sulfate.

8. The artificial turf of claim 1, wherein the acrylic binder comprises, based on the total weight of the acrylic binder
from 80 wt % to 99 wt % of the acrylic polymer;
from 0.05 wt % to 5 wt % of the at least one inorganic neutralizer; and
from 0.1 wt % to 5 wt % of the at least one surfactant.

9. A process comprising:
(1) providing a batch comprising an artificial turf and a wash solution, the artificial turf comprising
A. a primary backing layer having a plurality of artificial turf yarns projecting upwardly therefrom; and
B. a secondary backing layer in contact with the primary backing layer, the secondary backing layer comprising an acrylic binder comprising
(i) an acrylic polymer comprising polymerized units of
(a) a first monomer that is a C₄-C₁₈ alkyl acrylate; and
(b) a second monomer selected from the group consisting of a C₁-C₃ alkyl acrylate optionally containing a hydroxyl group, acrylic acid, and methacrylic acid;
(ii) at least one inorganic neutralizer; and
(iii) at least one surfactant; and
the wash solution comprising water, a surfactant, and a base;
(2) contacting the artificial turf with the wash solution under conditions sufficient to separate the secondary backing layer from the primary backing layer.

10. The process of claim 9, wherein the contacting step comprises immersing the artificial turf in the wash solution and agitating the artificial turf and the wash solution.

11. The process of claim 9, wherein the base is sodium hydroxide.

12. The process of claim 9, wherein the surfactant comprises a non-ionic secondary alcohol ethoxylate.

13. The process of claim 9, wherein the wash solution has from 0.1 wt % to 5 wt % of the base, based on the total weight of the wash solution.

14. The process of claim 9, wherein the wash solution has from 0.05 wt % to 5 wt % of the surfactant, based on the total weight of the wash solution.
